(19) United States
(12) Patent Application Publication
(10) Pub. No.: US 2009/0025154 A1
(43) Pub. Date: Jan. 29, 2009

(54) Vehicle And Equipment Hauler Attachment For Pickup Trucks

(76) Inventor: Forrest Sanders Smith, ST George, SC (US)

Correspondence Address: CALHOUN "REB" THOMAS, III, 1201 MAIN STREET, SUITE 1750, COLUMBIA, SC, 29201, US

(21) Appl. No.: 12/179,124

(22) Filed: Jul. 24, 2008

Related U.S. Application Data
(60) Provisional application No. 60/951,675, filed on Jul. 24, 2007.

(51) Int. Cl. B65G 69/28; B60P 1/02

(52) U.S. Cl. 14/71.7; 414/495

(57) ABSTRACT

The invention is a vehicle and equipment hauler attachment for pickup trucks. It allows a standard pickup truck to haul vehicles and other equipment such as zero turn radius lawn mowers and ATVs above the bed of the pickup truck while preserving storage and other towing options. The invention comprises a framing system to support the apparatus and to attach it to the bed of the pickup truck; a ramping system to aid in moving the vehicles and equipment; a decking system to support the vehicles and equipment; and a lifting system utilizing hydraulics and a winch.

### RELATED APPLICATIONS

This application claims priority from the earlier filed U.S. Provisional Application having Ser. No. 60/951675.

### FEDERALLY SPONSORED RESEARCH OR DEVELOPMENT

Not applicable.

### REFERENCED OR INCORPORATED MATERIAL

Not applicable.

### BACKGROUND OF INVENTION

The present invention relates to the field of transportation of small vehicles and mobile equipment via pickup trucks. Such vehicles include small personal ATVs, motorcycles, golf carts, go-carts, lawn tractors, lawn mowers having zero turn radiuses, and the like.

For those persons wishing to haul or otherwise transport one of these vehicles via a pickup truck, such persons are limited to either placing the vehicle in the bed of the truck or placing the vehicle on a trailer pulled by the truck. The former option only works when the vehicle is small enough to fit between the wheel wells of the truck bed and the latter, of course, requires the truck to tow still another wheeled device. Placing a vehicle in the truck bed further limits storage options for other peripherals and materials. Likewise, towing a trailer dedicated to the vehicle transportation limits towing options for other items that a person may desire to tow on the same trip such as a boat trailer, utility trailer, dump trailer, or a camping trailer. Furthermore, avoiding pulling a trailer will reduce accidents associated with trailers as well as enable a user to parallel park their pickup truck or park it in a head in parking space without having the problem of the extended trailer.

Thus, there exists a need in the art for a device that allows a pickup truck to haul a vehicle without pulling a trailer or otherwise severely limiting the storage area of the pickup truck bed.

### SUMMARY OF THE INVENTION

The present invention is a vehicle and equipment hauler attachment for pickup trucks. It is designed to allow vehicles such as personal ATVs, motorcycles, golf carts, go-carts, lawn tractors, lawn mowers having zero turn radiuses, and the like to be hauled above the bed of pickup trucks.

It is an object of the invention to provide a vehicle and equipment hauler capable of hauling lightweight vehicles and equipment weighing only a few hundred pounds as well of vehicles and equipment weighing more than a thousand pounds. It is an object of the present invention that these vehicles and pieces of equipment will be carried above the bed of the pickup truck. It is a further object of the present invention that the vehicles and pieces of equipment will be displaced into the position above the bed of a pickup truck via a lifting ramp system utilizing hydraulics and an inclined ramp as well the vehicles' own motive power and/or a lifting winch.

It is a further object of the invention that the frame, deck, and ramping components be made of materials of lightweight relative to the respective vehicles and equipment to be hauled. Such material may be aluminum or rolled steel for lighter weight vehicles or bar steel stock for heavier vehicles.

It is a further object of the invention that the hauler attachment be adaptable to many different makes and sizes of pickup truck beds.

It is still a further object of the invention that storage space in the bed of the pickup truck below the deck level be conserved.

### BRIEF DESCRIPTION OF THE SEVERAL VIEWS OF THE DRAWINGS

FIG. 1 is a side view of the invention attached to a pickup truck showing a vehicle loaded on the apparatus in the stowed position

FIG. 2A is a side view of the invention in one of the intermediate positions between the loading position and the stowed position wherein the hydraulic extending cylinder has been operated to extend deck system.

FIG. 2B is a side view of the invention in one of the intermediate positions between the loading position and the stowed position wherein both the hydraulic extending cylinder and the hydraulic lifting cylinder have been operated to extend and rotate the decking system.

FIG. 2C is a side view of the invention in the loading position wherein both the hydraulic extending cylinder and the hydraulic lifting cylinder have been operated to extend and rotate the decking system and wherein the ramps of the decking system have been extended.

FIG. 2D is a side view of the invention in the loading position wherein both the hydraulic extending cylinder and the hydraulic lifting cylinder have been operated to extend and rotate the decking system and wherein the ramps of the decking system have been extended and the vehicle moved down the ramps.

FIG. 3 is a perspective view of the invention with the deck surface and left side ramp removed.

FIG. 4 is a perspective exploded view of the invention with deck surface and the left side ramp removed.

FIG. 5 is a perspective exploded view of the invention showing single deck embodiment.

FIG. 6 is a perspective view of the invention showing the sub ramp pair embodiment in the loading position.

FIG. 7 is a perspective view of the invention showing the sub ramp pair embodiment in the loading position and highlighting the tread and the sliding track system.

FIG. 8 is a perspective view of the invention showing the single deck embodiment in the loading position and highlighting the tread.

FIG. 9A is a side view of the invention in the stowed position.

FIG. 9B is a side view of the invention in an intermediate position between the loading position and the stowed position wherein the hydraulic lifting cylinder has been operated.

FIG. 10A is a side view of the invention in an intermediate position between the loading position and the stowed position wherein both the hydraulic lifting cylinder and the hydraulic extending cylinder have been operated.

FIG. 10B is a side view of the invention in an intermediate position between the loading position and the stowed position wherein both the hydraulic lifting cylinder and the hydraulic extending cylinder have been operated and wherein the ramps have been extended.

### DETAILED DESCRIPTION

It is to be understood by a person having ordinary skill in the art that the present discussion is a description of exemplary embodiments only, and is not intended as limiting the broader aspects of the present invention. The following example is provided to further illustrate the invention and is not to be construed to unduly limit the scope of the invention.

The invention generally comprises a framing system, a decking system, a ramping system, and a lifting system. The framing system attaches the apparatus to the truck (10) bed. The framing system also supports the decking system and the ramping system and houses the lifting system. The decking system provides a planar floor on which the vehicle rests while hauling. The ramping system provides an inclined structure to enable the vehicle to traverse the deck when being loaded from the ground. The lifting system provides hydraulics for lifting the decking and ramping system components and a winch for pulling the vehicles into place.

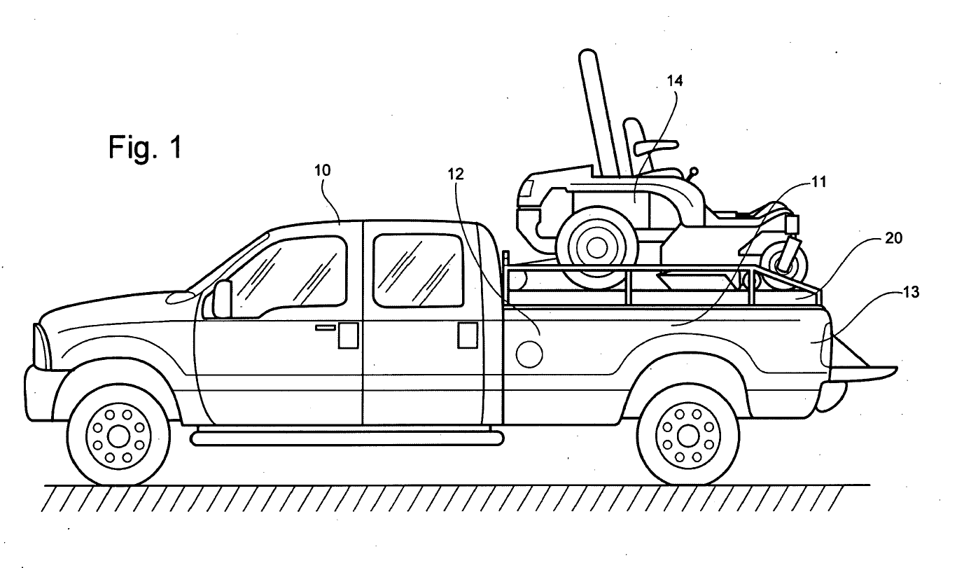

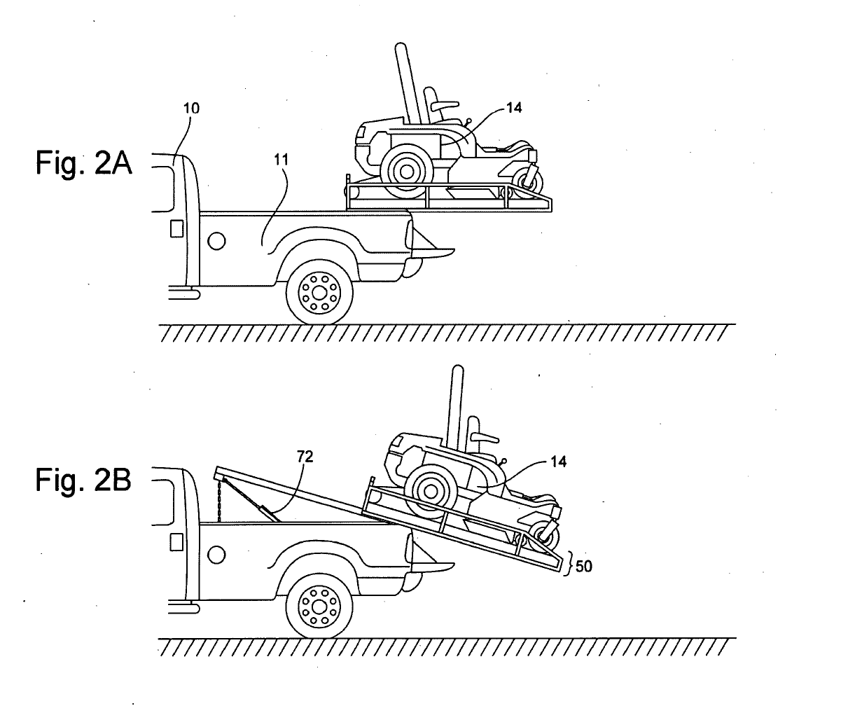

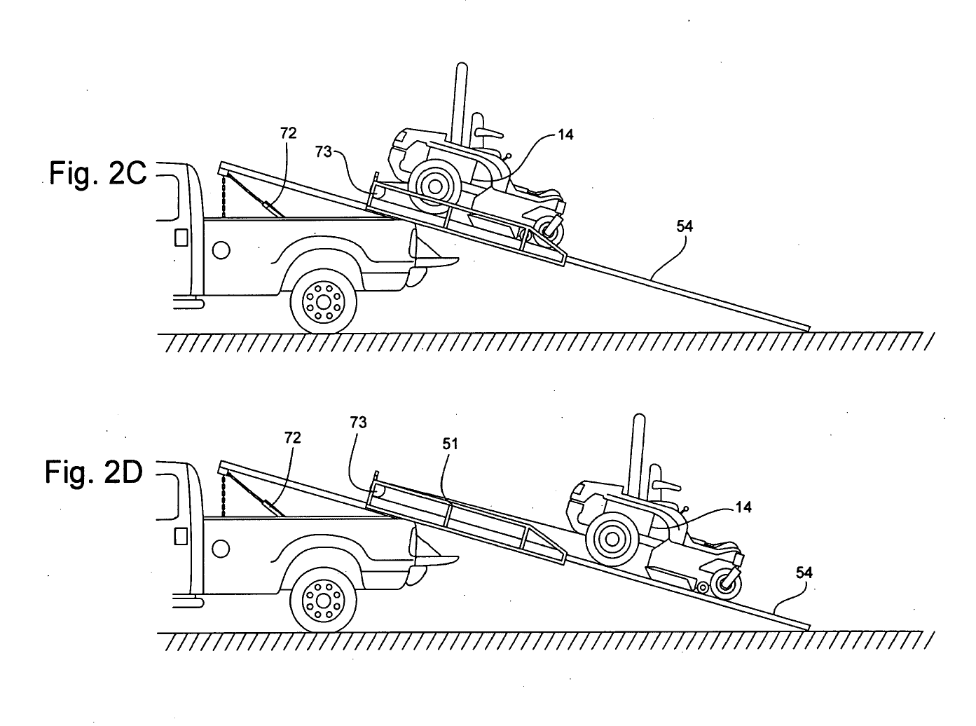

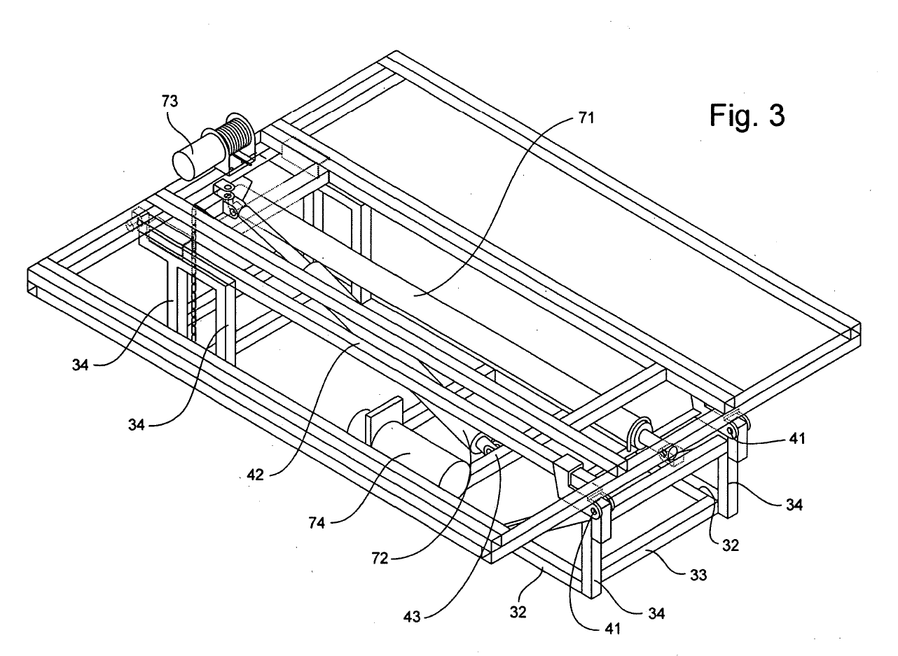

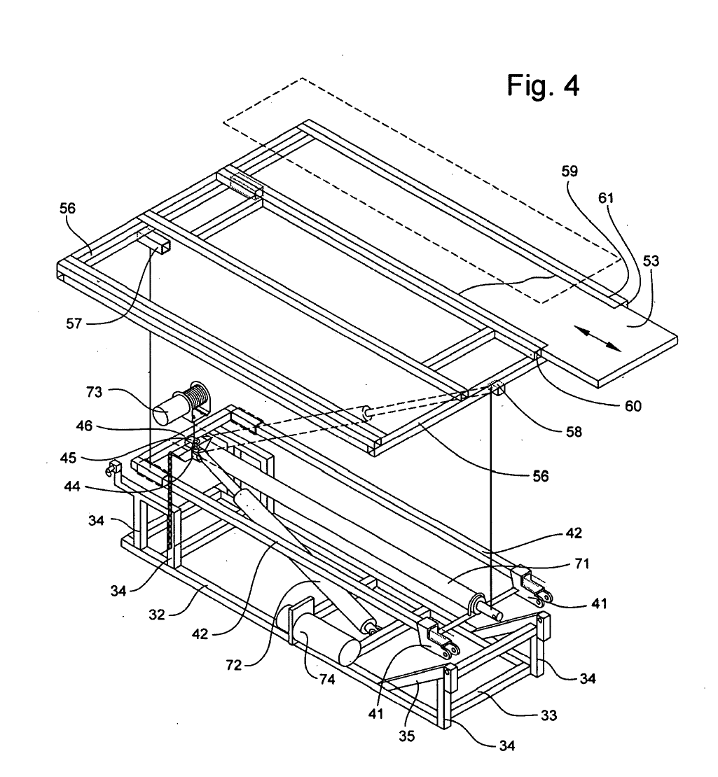

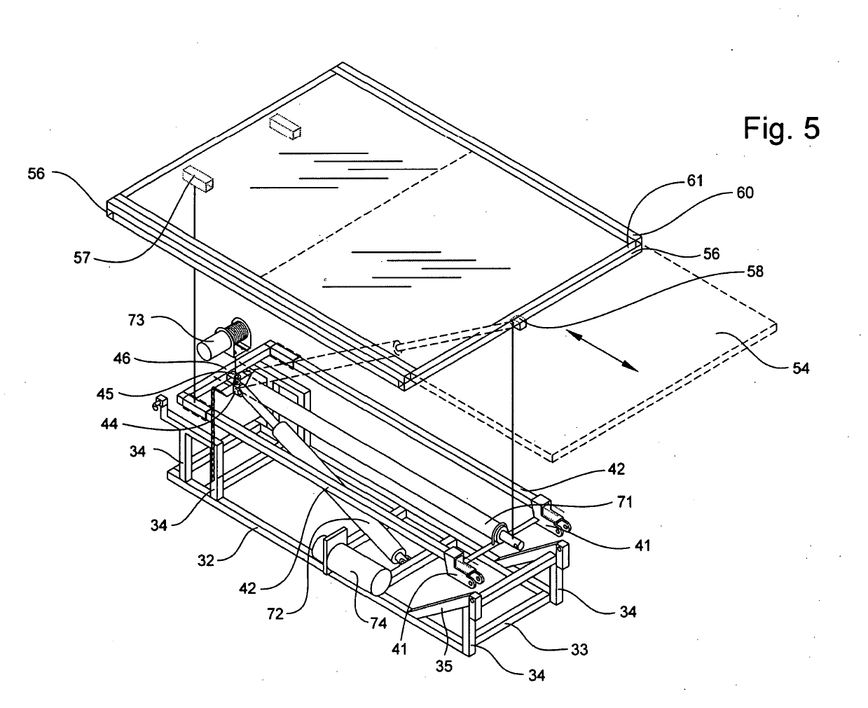

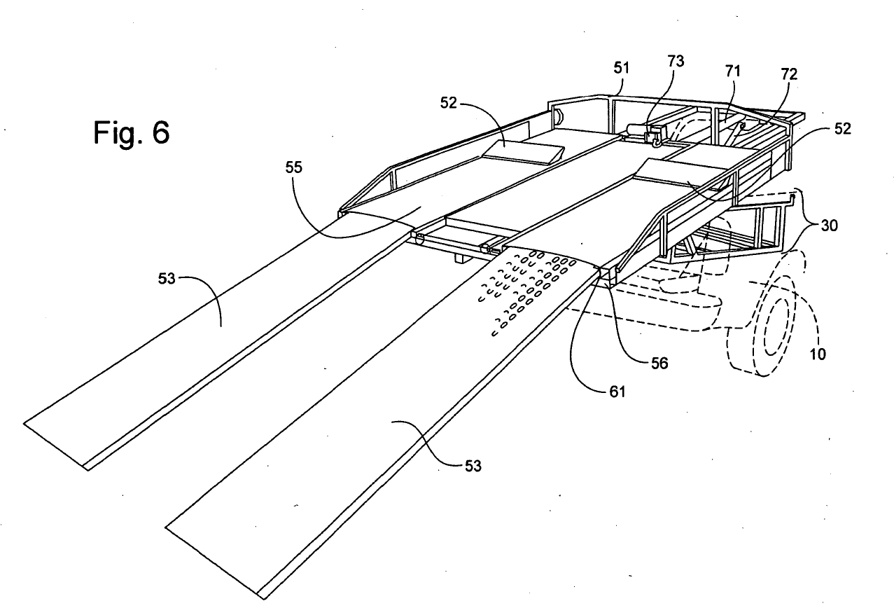

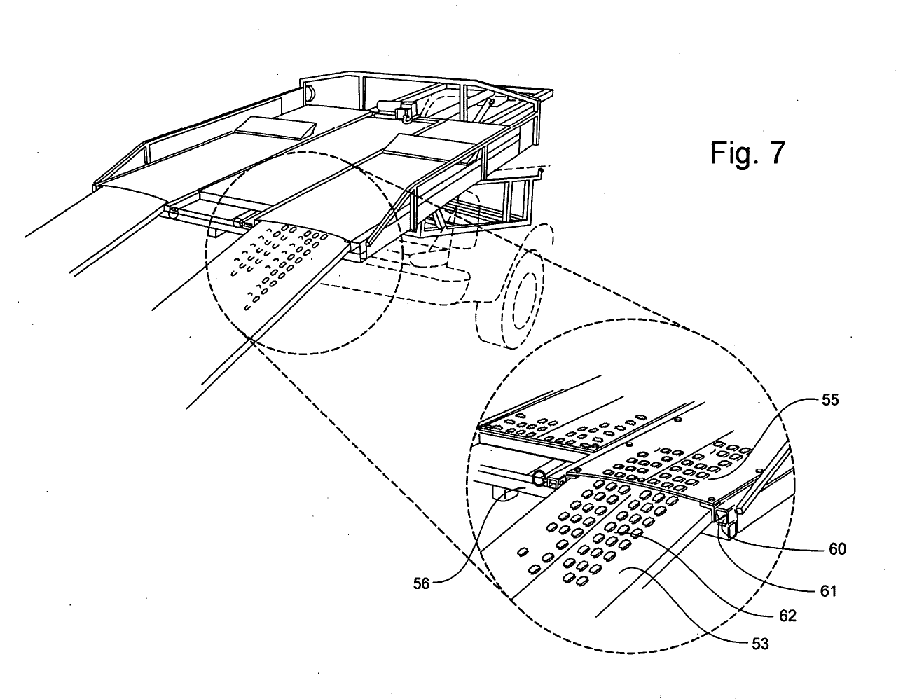

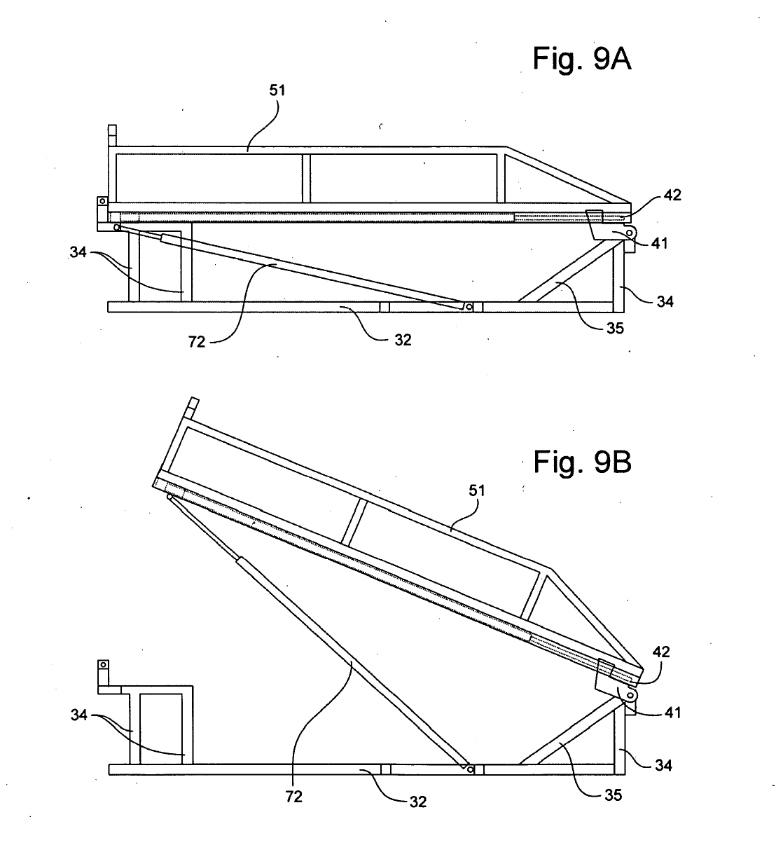

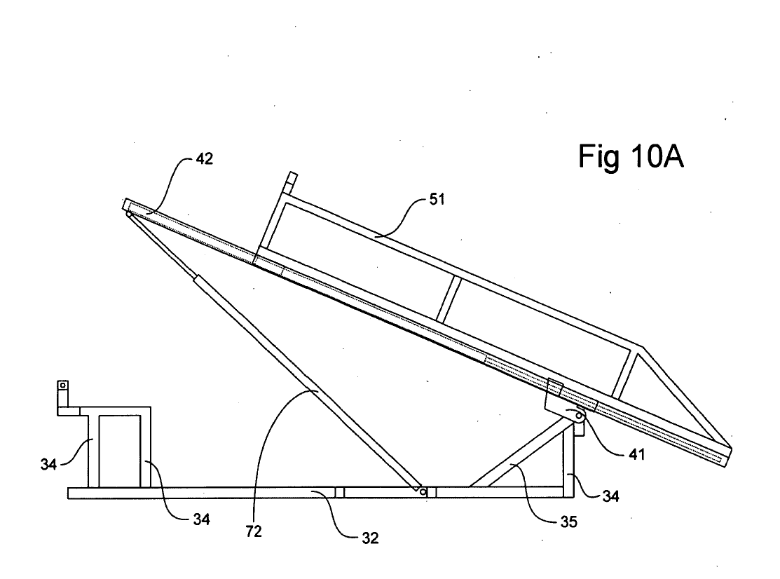

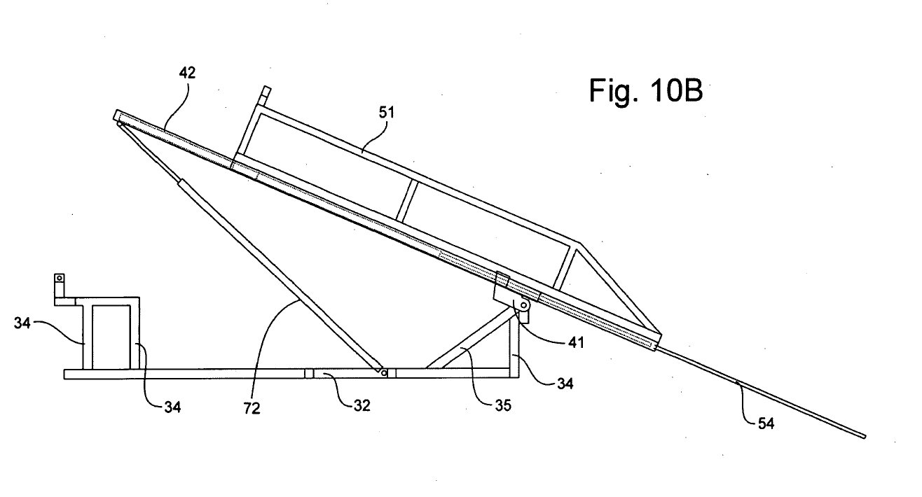

The apparatus is designed to operate between two fixed positions, a stowed position (as shown in FIG. 1 and FIG. 9A) and a loading position (as shown in FIG. 2C, FIG. 2D, FIGS. 6-8, and FIG. 10B) There are also several transitional or intermediate positions between the two fixed positions whereby the vehicle and respective components of the apparatus are moved into the stowed (as shown in FIG. 2A, FIG. 2B, FIG. 9B, and FIG. 10A). As used herein, horizontal position refers to the particular subject component being horizontal with respect to pickup truck (10) when the vehicle and equipment hauler attachment for pickup trucks is in the stowed position.

The framing system comprises horizontal supports (32 & 33), vertical pillars (34), and, in alternate embodiments, angled stabilizers (35). At least two long horizontal supports (32) run parallel to the length of the truck body. In alternate embodiments, rather than being of fixed length, these supports are adjustable and may be lengthened or shortened to fit varying pickup truck bed lengths. One of the ways this adjustability comes is via a pin connection whereby a portion of each of the supports has a smaller cross section and fits inside the portion of the respective support having a larger cross section. The portions having a larger cross section have an opened end and a pair of holes on opposite sides. The portions having a smaller cross section have a series of parallel holes disposed on opposite sides. The portions of the supports having the smaller cross sections may then be slid into the portions having the larger cross sections. In this way, the appropriate holes may be lined up to fit the length of the truck bed. The holes having been aligned, a pin is inserted through the holes in the respective supports to temporarily fix the length. A person of ordinary skill in the art will recognize that there are alternate ways to achieve this adjustability and the foregoing example is not intended to limit the scope of the invention.

At least two horizontal supports also run perpendicular to the length of the pickup truck body (33). In the preferred embodiment, these supports are fixedly attached to the horizontal supports (32) running parallel to the truck body. Alternatively, these supports (33) may also be made to be adjustable, using either the same pin type connection as with the horizontal parallel supports (32) of the framing system or other standard mechanisms for adjustability.

The vertical pillars (34) are perpendicular and fixedly attached to the horizontal supports (32) which run parallel to the truck. There are at least four vertical pillars (34) and there are six in the preferred embodiment. Like the horizontal supports (32 & 33), the vertical pillars (34) are adjustable in alternative embodiments such that the height may be adjusted to account for different pickup truck bed heights. In alternate embodiments, the vertical pillars (34) are further supported by angled supports (35) which are fixedly attached to the horizontal supports (32).

At the end of the truck bed nearest the truck cab—the front end—there are two more horizontal supports. These supports run parallel to the length of the truck but are shorter and, in the preferred embodiment, are fixedly attached to the two front vertical pillars (34). These horizontal supports provide support for the deck of the apparatus when in the stowed position.

The ramping system attaches to the framing system via a hinged connection (41). In the preferred embodiment, this hinged connection utilizes flip hinges (41). The ramping system comprises two parallel horizontal supports (42) (horizontal with respect to the truck bed in the stowed position) which rotate about the hinged connection (41) to the framing and a perpendicular horizontal (43) support fixedly attached to and running between the parallel horizontal supports (42). The parallel horizontal supports (42) of the ramping system also provide the function of rails for parallel cuffs (57) of the decking system to traverse. The ramping system also further comprises connection points for the hydraulic lifting cylinder of the lifting system (44), the hydraulic extending cylinder of the lifting system (45), and the winch of the lifting system (46).

The ramping system is integral to both the decking system and the lifting system.

The decking system comprises a deck frame (56), a deck surface (55), and a deck rail system (51). The ultimate purpose of the decking system is to provide a platform for the loading and stowing vehicles (14). The deck frame (56) provides support for the deck surface (55). The deck surface (55) provides the physical platform for the vehicles (14) to rest on and the tread (62) to aid in loading and unloading. The deck rail system (51) provides security for objects placed on the deck surface as well as tie-down points for security straps. In alternate embodiments, there is also disposed on the deck surface a pair of wheel chocks (52) for securing the vehicle in place.

The decking system may take on many forms but there are at least two primary embodiments. The first embodiment contemplates two sub deck “ramps” (53) which slide out to aid in loading and unloading. The second embodiment contemplates a single deck (54) which slides out of the primary deck frame (56).

In both of the primary embodiments, the deck frame (56) of the decking system further comprises a rectangular frame (56) with bracing and parallel cuffs (57) which slide along the parallel horizontal supports (42) of the ramping system. There is also disposed on the rear end a connection point to (58) the hydraulic extending cylinder (71) of the lift system.

Fixedly attached directly to the top of the deck frame is a sliding track (59) system. In the embodiment utilizing two sub deck “ramps” (53), these sub decks (53) are stored in and pull out from this sliding track system (59). The sliding track system (59) comprises four supports (60) that are parallel to the length of the pickup truck bed and two pair of inwardly facing “C” shaped tracks (61) which respectfully accept the pair of sub deck ramps (53). In this embodiment, the deck surface (55) is fixedly attached to the top of these four supports (60) of the sliding track system of the deck frame of the decking system.

In the embodiment comprising a single deck (54) which slides out of the primary deck frame (56), the sliding track system (59) comprises two supports (60) that are parallel to the length of the pickup truck bed and one pair of inwardly facing “C” shaped tracks (61) which accept the sliding deck (54). In this embodiment, there is no additional deck surface as the deck surface is attached directly to the single sliding deck. This sliding deck may have its own secondary deck frame to aid in structural stability.

The lifting system comprises the hydraulic cylinders, the winch, and a control means. There are two hydraulic cylinders, namely the hydraulic lifting cylinder (72) and the hydraulic extending cylinder (71). Both are provided with hydraulic fluid from a hydraulic pump (74) mounted on the framing system (30). The hydraulic lifting cylinder (72) is rotatably attached to the framing system (30) and likewise rotatably attached (44) to the inside of the front end of the ramping system. When the appropriate function of the control means is activated by a user, the hydraulic lifting cylinder (72) vertically displaces parallel supports (42) and the perpendicular horizontal support (43) of the ramping system which rotate about rear end of the framing system via the flip hinges (41).

The hydraulic extending cylinder (71) is attached (45) to the front end of the ramping system and also to the rear end (58) of the decking system. When the appropriate function of the control means is activated by the user, the hydraulic extending cylinder (71) horizontally displaces decking system over the end of the pickup truck (10) in a direction away from the front end of the pickup truck bed.

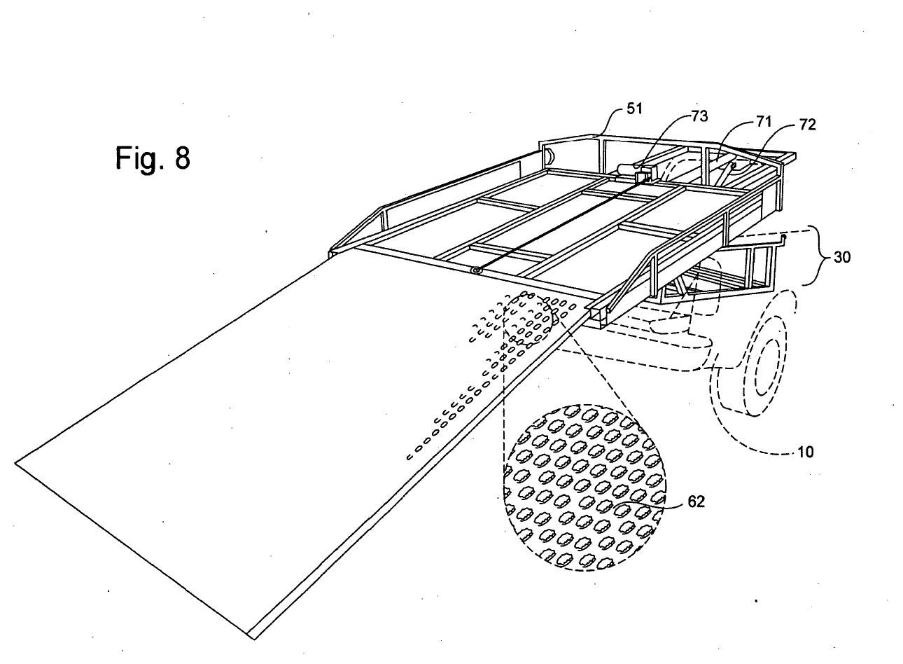

The winch (73) is attached to the top surface of the ramping system's perpendicular horizontal support (43). The winch (73) is also preferably electrically connected to the control means of the lifting system. The winch is a winch readily found in the art of vehicles and it is used herein to aid pulling the vehicle (14) onto the deck surface (55). In the embodiment of the decking system comprising a single deck (54) which slides out of the primary deck frame (56), the winch (73) further aids in pulling the sliding deck (54) back into the primary deck frame as shown in FIG. 8.

What is claimed is:

1. A vehicle and equipment hauler attachment for pickup trucks comprising: a frame attached to the pickup truck bed; a winch attached to said frame; a plurality of hydraulic cylinders attached to said frame; a deck rotatably attached to said hydraulic cylinders and to said frame; and a ramp slidingly attached to said deck.

2. The vehicle and equipment hauler attachment for pickup trucks of claim 1 wherein the vehicle and equipment hauler attachment operates via use of said hydraulic cylinders from a stowed position where said deck is just above the sides of the pickup truck bed to a loading position where said deck extends over the tailgate of the pickup truck and the ramps touch the ground.

3. The vehicle and equipment hauler attachment for pickup trucks of claim 2 wherein the frame is adjustable to fit both the length of the bed of the pickup truck and the height of the sides of the bed of a pickup truck.

4. A vehicle and equipment hauler attachment for pickup trucks comprising:
a framing system, a ramping system, a decking system, and a lifting system, each of said framing, decking, ramping, and lifting systems collectively operating from a stowed position to a loading position; said framing system comprising a plurality of horizontal supports and a plurality of vertical pillars; said ramping system comprising a plurality of parallel horizontal supports and a perpendicular horizontal support attached to each of said parallel horizontal supports, said plurality of parallel horizontal supports being hingedly attached to the vertical pillars of said framing system; said decking system comprising a deck frame, and a deck surface, said deck frame being slidingly attached to the parallel horizontal supports of the ramping system; said lifting system further comprising a plurality of hydraulic cylinders for lifting the ramping system and for extending the deck frame, a winch, and a control means for controlling the hydraulic cylinders and the winch.

5. The vehicle and equipment hauler attachment for pickup trucks of claim 4 wherein said decking system further comprises a deck rail and wherein the deck frame of said decking system is a rectangular frame and further comprises a plurality of cuffs for facilitating the sliding attachment to the parallel horizontal supports of the ramping system.

6. The vehicle and equipment hauler attachment for pickup trucks of claim 5 wherein the decking system further comprises a sliding track system fixedly attached to the top surface of the rectangular frame.

7. The vehicle and equipment hauler attachment for pickup trucks of claim 6 wherein the sliding track system of the deck frame of the decking system further comprises a pair of parallel ramps, slidingly attached to the sliding track system for loading and unloading vehicles and equipment.

8. The vehicle and equipment hauler attachment for pickup trucks of claim 6 wherein the deck surface of the decking system is slidingly attached to the sliding track system for loading and unloading vehicles and equipment.

9. The vehicle and equipment hauler attachment for pickup trucks of claim 6 wherein said plurality of horizontal supports and said plurality of vertical pillars of the framing system are adjustable to fit different size pickup truck beds.

10. The vehicle and equipment hauler attachment for pickup trucks of claim 9 wherein a plurality of hydraulic cylinders of the lifting system further comprises a hydraulic pump, a hydraulic lifting cylinder, and a hydraulic extending cylinder; said hydraulic lifting cylinder being rotatably attached to the framing system and rotatably attached to the inside of the front end of the ramping system, said hydraulic extending cylinder being attached to the front end of said ramping system and to the rear end of said decking system, and said hydraulic pump fixedly attached to the framing system.

11. The vehicle and equipment hauler attachment for pickup trucks of claim 9 wherein said plurality of horizontal supports and said plurality of vertical pillars of the framing system, said plurality of parallel horizontal supports and said perpendicular horizontal support of the ramping system, and said deck frame and said deck surface of the decking system are made of roll formed steel.

12. The vehicle and equipment hauler attachment for pickup trucks of claim 9 wherein said plurality of horizontal supports and said plurality of vertical pillars of the framing system, said plurality of parallel horizontal supports and said perpendicular horizontal support of the ramping system, and said deck frame and said deck surface of the decking system are made of aluminum.

13. The vehicle and equipment hauler attachment for pickup trucks of claim 9 wherein said decking system further comprises a pair of wheel chocks disposed on said deck surface.

14. A vehicle and equipment hauler attachment for pickup trucks comprising:
a framing system, a decking system, a ramping system, and a lifting system, each of said framing, decking, ramping, and lifting systems collectively operating from a stowed position to a loading position; said framing system comprising a left horizontal support, a right horizontal support, a plurality of center horizontal supports, a front left vertical pillar, a front right vertical pillar, a rear left vertical pillar, and a rear right vertical pillar; said ramping system comprising a left parallel horizontal support, a right parallel horizontal support, and a perpendicular horizontal support attached to both the left and the right parallel horizontal supports, said left parallel horizontal support being hingedly attached to the rear left vertical pillar of said framing system and said right parallel horizontal support being hingedly attached to the rear right vertical pillar of said framing system; said decking system comprising a deck frame, a deck rail, a deck surface, and a pair of deck wheel chocks, said deck frame further comprising a pair of cuffs slidingly attached to the left and right parallel horizontal supports of the ramping system and also comprising a sliding track system disposed on the top surface of the deck frame of the decking system, and said deck surface having treads; said lifting system further comprising a plurality of hydraulic cylinders for lifting the ramping system and for extending the deck frame, a winch, and a control means for controlling the hydraulic cylinders and the winch, said plurality of hydraulic cylinders further comprising a hydraulic pump, a hydraulic lifting cylinder, and a hydraulic extending cylinder, said hydraulic lifting cylinder being rotatably attached to one of said center horizontal supports of the framing system and rotatably attached to the perpendicular horizontal support of the ramping system, said hydraulic extending cylinder being attached to the perpendicular horizontal support of said ramping system and to the rear end of said decking system, and said hydraulic pump fixedly attached to the framing system.

15. The vehicle and equipment hauler attachment for pickup trucks of claim 14 wherein the sliding track system of the deck frame of the decking system further comprises a pair of parallel ramps, slidingly attached to the sliding track system for loading and unloading vehicles and equipment.

16. The vehicle and equipment hauler attachment for pickup trucks of claim 14 wherein the deck surface of the decking system is slidingly attached to the sliding track system for loading and unloading vehicles and equipment.

17. The vehicle and equipment hauler attachment for pickup trucks of claim 14 wherein said left horizontal support, said right horizontal support, said plurality of center horizontal supports, said front left vertical pillar, said front right vertical pillar, said rear left vertical pillar, and said rear right vertical pillar of the framing system, said left parallel horizontal support, said right parallel horizontal support, and said perpendicular horizontal support, and said deck frame, said deck rail, and said deck surface are made from steel.

18. The vehicle and equipment hauler attachment for pickup trucks of claim 14 wherein said left horizontal support, said right horizontal support, said plurality of center horizontal supports, said front left vertical pillar, said front right vertical pillar, said rear left vertical pillar, and said rear right vertical pillar of the framing system, said left parallel horizontal support, said right parallel horizontal support, and said perpendicular horizontal support of the ramping system, and said deck frame, said deck rail, and said deck surface of the decking system are made from roll formed steel.

19. The vehicle and equipment hauler attachment for pickup trucks of claim 14 wherein said left horizontal support, said right horizontal support, said plurality of center horizontal supports, said front left vertical pillar, said front right vertical pillar, said rear left vertical pillar, and said rear right vertical pillar of the framing system, said left parallel horizontal support, said right parallel horizontal support, and said perpendicular horizontal support of the ramping system, and said deck frame, said deck rail, and said deck surface of the decking system are made from aluminum.

20. The vehicle and equipment hauler attachment for pickup trucks of claim 14 wherein said left horizontal support, said right horizontal support, said plurality of center horizontal supports, said front left vertical pillar, said front right vertical pillar, said rear left vertical pillar, and said rear right vertical pillar of the framing system, and said left parallel horizontal support, said right parallel horizontal support, and said perpendicular horizontal support of the ramping system are made of steel and said deck frame, said deck rail, and said deck surface of the decking system are made from aluminum.
